(19) United States
(12) Patent Application Publication
(10) Pub. No.: US 2009/0308688 A1
(43) Pub. Date: Dec. 17, 2009

(54) FOLDABLE STEP DEVICE AND METHOD

(76) Inventor: Eliahu TAYAR, Moshav Ramat Tzvi (IL)

Correspondence Address: Pearl Cohen Zedek Latzer, LLP, 1500 Broadway, 12th Floor, New York, NY, 10036, US

(21) Appl. No.: 12/486,142

(22) Filed: Jun. 17, 2009

Related U.S. Application Data
(60) Provisional application No. 61/073,097, filed on Jun. 17, 2008.

(51) Int. Cl. E06C 9/08; B60R 3/02; E06C 1/38

(52) U.S. Cl. 182/89; 182/91

(57) ABSTRACT

A foldable step apparatus comprising a foldable parallelepiped frame with a safety locking mechanism, a step, and a tension device, such as a spring, to enable easy folding and unfolding.

### CROSS REFERENCE TO RELATED APPLICATIONS

This Application claims the benefit of U.S. Provisional Application Ser. No. 61/073,097, filed Jun. 17, 2008, which is hereby incorporated by reference in its entirety.

### BACKGROUND OF THE INVENTION

Numerous means and devices for handicapped access to vehicles, buildings, etc., are known. They may be mechanical, electric, or hydraulic in nature, or may consist of any combination thereof. Most of these, however, are too bulky, too heavy, too cumbersome and troublesome to use, may require maintenance, or are expensive.

### SUMMARY OF THE INVENTION

The present invention offers a simple and inexpensive means of handicapped access. It consists of a foldable mechanical step device, which is easy to use and can be installed on vehicles, at entrances to buildings, etc., consuming limited additional space underneath the chassis to which it is attached.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a perspective schematic drawing of a device according to embodiments of the present invention in an open and ready to be used position;

FIG. 2 is a perspective schematic drawing of a device according to embodiments of the present invention in a closed and stowed-away position;

FIG. 3 is a schematic side view drawing of a device according to embodiments of the present invention in an open position;

FIG. 4 is a schematic side view drawing of a device according to embodiments of the present invention in an intermediate position;

FIG. 5 is a schematic side view drawing of a device according to embodiments of the present invention in a closed position; and

FIG. 6 is a close-up view of FIG. 3, showing greater detail.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

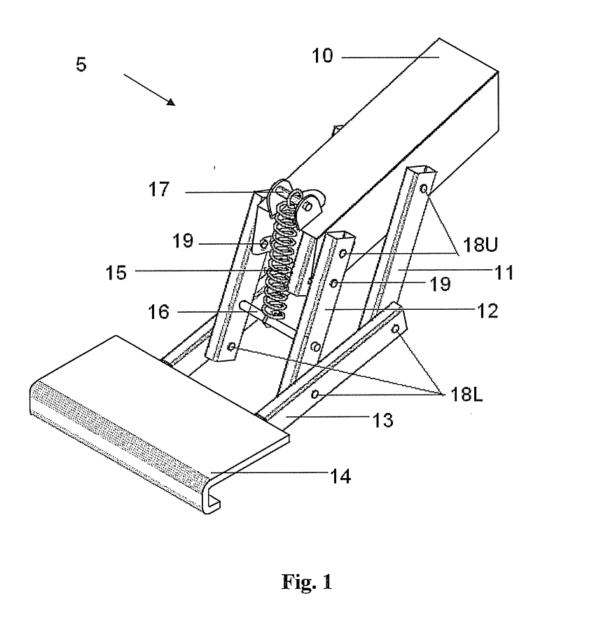

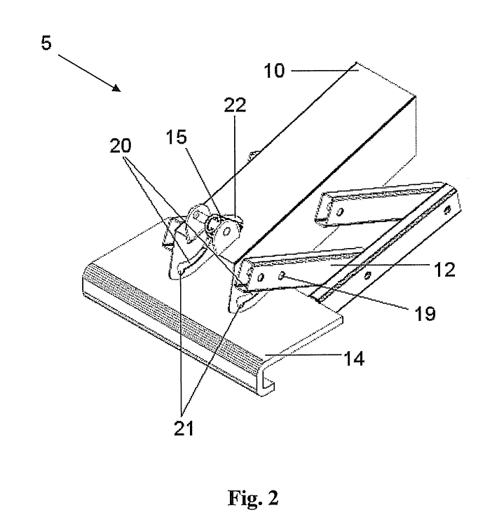

Reference is now made to FIG. 1, which is a perspective schematic drawing of device 5 according to embodiments of the present invention in an open and ready to be used position. Device 5 may comprise platform 10, which may be a part of a vehicle's underside (or any other section thereof), a door entrance step, or the like, to which pivoting arms 11, 12, and 13 may be attached, for example, by means of pins 18U and 18L, thereby forming substantially a parallelepiped or a similar figure. It will be apparent that other embodiments of device 5 may be attached by means other than platform 10, and that device 5 may not comprise platform 10 in other embodiments, which would still be within the scope of the invention. Step 14 may be attached to arm 13 or even be a part of it and may form the surface stepped upon or be the surface upon which other type of pressure may be applied. Device 5 may further comprise tensioning device 15, for example a spring. From hereon down to the end of the description of the invention, tensioning device 15 will be called spring 15 for clarity, yet it will be apparent that other devices and means of providing a tensioning force may be used and are within the scope of the invention. Spring 15 may be connected between platform 10 and either one of pivoting arms 11, 12 and 13, so that its tension, when device 5 is in its stowed position or in its extracted position, is lower than when device 5 is in at least one intermediate position, said at least one intermediate position being a local maximum tension position. Spring 15 may enable easy retraction of device 5, as well as easy unlocking and stowing away into the folded position as will be explained in details below. Spring 15 may be held in place by pins 16 and 17. Spring 15 may apply its tensioning force between pin 17 attached to platform 10 and pin 16 attached, for example, to pivoting arm 12. Pins 19 may perform a locking function, further explained in reference to FIGS. 2 and 6 below.

Reference is now made to FIG. 2, which is a perspective schematic drawing of device 5 according to embodiments of the present invention in a closed and stowed-away position. Device 5 may further comprise at least one curved slot 20 on either side of platform 10 to limit the angles of device 5 in its folded and extended positions, yet it should be apparent that other arrangements to limit the extension or folding in of device 5 may be used within the scope of the present invention. Safety lock holes 21 substantially at the ends of slots 20, which are corresponding to the open position of device 5, allow the device to be locked in place once it is retracted into the open position and pressure is applied substantially vertically to step 14. Pins 19 of FIG. 1 may perform a locking function when step 14 is fully extended out, at which point substantially vertical pressure may be applied upon step 14 by, for example, stepping on it, which would make pins 19 drop down into elongated safety lock holes 21, thereby safely locking pivot arm 12 and, therefore, all of device 5 into place. Platform 10 may further comprise cutout 22 to allow spring 15 to rotate undisturbed on pin 17 when device 5 is folded for storage, yet it should be apparent that other arrangements to allow free rotation of spring 15 are within the scope of the present invention.

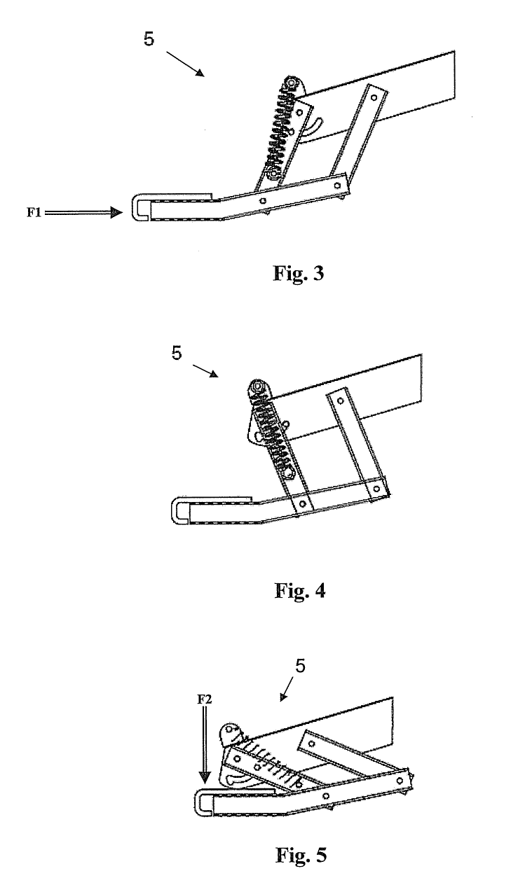

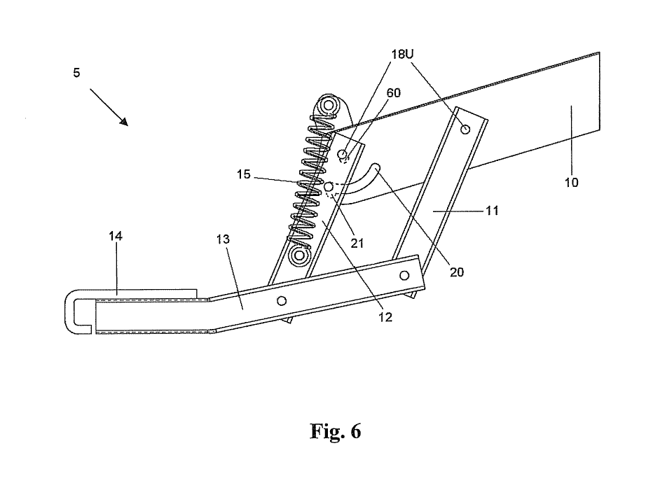

Reference is now made to FIG. 3, which is a schematic side view drawing of device 5 according to embodiments of the present invention in an open position. Reference is also made to FIGS. 4 and 5, which are schematic side view drawings of device 5 in an intermediate position and in the closed position, respectively, according to embodiments of the present invention.

FIG. 6 is a close-up view of FIG. 3, showing in greater detail the side view of device 5 in the open position according to an embodiment of the invention. Pivoting arms 11 and 12 may rotate about upper pins 18. Since pivoting arms 11, 12, and 13 are tied together, they move together with respect to platform 10. Elongated holes 60 allow arms 12 to slide down under application of certain substantially vertical force on step 14 (see FIG. 5). Pins 19 from FIG. 1 may slide along slots 20 until they reach substantially vertically elongated locking holes 21 at the ends of slots 20 and may lock into place under the influence of substantially vertical downward force upon step 14 of FIG. 1. This force would cause pins 19 to drop down into locking holes 21. This same force would cause pins 18U to drop down along elongated locking holes 60.

According to an embodiment of the invention, when device 5 is in its open, extended, and locked position as shown in FIG. 3, it may be returned into the folded position of FIG. 5 by applying force F1 at the tip of step 14 substantially horizontally, as depicted in FIG. 3 by the double-line arrow F1, until device 5 passes through the intermediate position of FIG. 4. The device will then go through the equilibrium point of spring 15 in FIG. 4 and will snap into its folded position in FIG. 5 under the tension from spring 15.

Conversely, when unfolding device 5 from its stowed-away position of FIG. 5, a person needs to apply at the tip of step 14 a force substantially vertically, as depicted in FIG. 5 by the double-line arrow F2, until device 5 passes through the intermediate equilibrium point of spring 15 as shown in FIG. 4, and will completely unfold and snap into place as shown in FIG. 3.

The relative dimensions and angles shown in FIGS. 1-6 were shown for illustrative purposes only. The actual physical properties, dimensions, and angles may differ from the ones shown.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a foldable frame, said frame comprising an upper side and a lower side, said lower side being able to pivot with respect to said upper side of said frame;
a step attached to said lower side of said frame;
a tension device connected to said upper side of said frame to provide a folding force to said lower side;
a means of limiting the range of relative movement of said lower side of said frame with respect to said upper side in a folded-in position and in an extended-out position; and
a means of locking said lower side in said extended-out position,
wherein said lower side is adapted to remain substantially parallel to said upper side when pivoting.

2. The apparatus of claim 1, wherein said step comprises a part of said lower arm.

3. The apparatus of claim 1, wherein said step forms a surface stepped upon or a surface upon which other type of pressure may be applied.

4. The apparatus of claim 1, wherein said means of locking is comprised of one or more substantially vertically elongated holes.

5. The apparatus of claim 1, wherein said means of limiting the range of relative movement of said lower side of said parallelepiped is comprised of one or more curved slots.

6. The apparatus of claim 1, wherein said lower side of said parallelepiped is comprised of one or more arms, wherein said arms are connected at substantially the ends of said arms by pins through holes in said arms.

7. The apparatus of claim 1, wherein said tension device connected between said stationary upper side of said parallelepiped and the rest of said apparatus is comprised of a spring.

8. A method comprising:
retracting an apparatus from its folded position by applying substantially vertical pressure;
locking said apparatus for use by applying substantially vertical pressure; and
folding and stowing away an apparatus from its open position by applying substantially horizontal pressure to the front side of said apparatus.
